(19) United States
(12) Patent Application Publication
(10) Pub. No.: US 2014/0309474 A1
(43) Pub. Date: Oct. 16, 2014

(54) PLASMA MELTING FURNACE, SYSTEM AND METHOD FOR WASTE TREATMENT

(71) Applicant: GS Platech Co., Ltd., Daejeon (KR)

(72) Inventors: Soon-Mo HWANG, Seoul (KR); Young-Suk KIM, Daejeon (KR); Cheul Jin DO, Daejeon (KR); Jin Ho LEE, Daejeon (KR); Byung-Ju YOO, Daejeon (KR)

(73) Assignee: GS Platech Co., Ltd., Daejeon (KR)

(21) Appl. No.: 14/247,230

(22) Filed: Apr. 7, 2014

(30) Foreign Application Priority Data
Apr. 11, 2013 (KR) 10-2013-0039957

(51) Int. Cl. A62D 3/19; F23G 5/027; B09B 3/00

(52) U.S. Cl. CPC A62D 3/19; B09B 3/0083; F23G 5/0276
USPC 588/311; 373/22; 373/8

(57) ABSTRACT

A melting furnace includes a waste inlet formed on a first side wall of the plasma melting furnace to feed waste therein, an exhaust gas outlet formed on a second side wall facing the first side wall and located diagonally to a direction orthogonal to the first side wall having the waste inlet to discharge the exhaust gas generated in the plasma melting furnace, and a plasma torch mounted on a third side wall for heating inside of the plasma melting furnace at a position nearer to the second side wall than the first side wall so as to inject a plasma into the exhaust gas.

### CROSS REFERENCE TO RELATED APPLICATIONS

This application claims priority to Korean Patent Application No. 10-2013-0039957, filed on Apr. 11, 2013 in the Korean Intellectual Property Office, the entire disclosure of which is incorporated herein by reference.

### BACKGROUND

1. Field of the Invention

The present invention relates to a plasma melting furnace for waste treatment by thermally decomposing and melting the same, a plasma melting system for waste treatment including the plasma melting furnace, and a method for waste treatment by thermally decomposing and melting the same using the plasma melting furnace.

2. Description of the Related Art

The quantity of waste in Korea is known to exceed 300,000 tons annually, and workplace waste continues to increase due to the increase of industrial activity. 50% or more of waste is disposed via landfill or incineration. Environmental pollution such as air pollution and groundwater and soil contamination due to toxic substances such as dioxin generated in the process of waste disposal is becoming a social issue. Furthermore, due to such environmental pollution, securing landfills is becoming more difficult and the social costs for landfills and waste incineration are increasing continuously.

Therefore, the demand for technical development, whereby environmental pollution generated in the waste treatment process can be reduced, is intensifying. Hence, a waste treatment technology using plasma is attracting recent attention.

Waste treatment technology using plasma, for example, is a technology whereby not only is environmental pollution not created, but also waste is recycled as an energy resource and inorganic matter is vitrified and reused as a construction material.

Specifically, in a waste treatment technology using plasma, waste is thermally decomposed at high temperatures of 1400° C. or greater in a plasma melting furnace, so the generation of dioxin, and the like, is minimized compared with conventional incineration treatment technologies, and also reduces environmental pollution innovatively by removing SOₓ, Cl₂, and other volatile metal components (lead (Pb), mercury (Hg), arsenic (As), etc.). Further, by thermal decomposition and gasification treatment of waste via high temperature plasma, thermally decomposing gases, including carbon monoxide and hydrogen, can be generated, and they are burned to be used for the generation of electric power or separated to produce purified hydrogen that can be used in fuel cells and other industrial purposes. Furthermore, slag generated during waste treatment via a plasma melting furnace does not elute poisonous heavy metal materials, therefore, the slag can be utilized in construction and building materials.

The plasma used in such a waste treatment technology is thermal plasma that can be generated by a plasma apparatus generating a direct or alternating current arc discharge, or a high frequency plasma apparatus via high-frequency magnetic fields. Thermal plasma is a partially ionized gas composed of electrons, ions, and neutral particles. It maintains a local thermodynamic equilibrium state, so that all the constituent particles form high-speed jet flame shapes having uniform temperatures ranging from thousands to tens of thousands of degrees centigrade.

A plasma torch is generally used to generate such a plasma. The plasma torch is known to be able to generate an extremely high temperature plasma jet by applying an arc to ionized plasma, thereby creating a high temperature atmosphere in the range of 4000 to 7000° C.

One of the representative methods in the plasma melting furnaces using such a plasma torch is the method whereby a powerful plasma jet is applied from the plasma torch in the apparatus to gasify waste at high temperatures and convert the residual material into melted material. As an example, a circulation type plasma thermal decomposing furnace is disclosed in Korean Patent Laid-Open Publication No. 2005-0104708.

### SUMMARY

It is an aspect of the present invention to provide a plasma melting furnace for waste treatment, as well as a system and a method for waste treatment using the same which can stably process waste in the plasma melting furnace for waste treatment.

Another aspect of the present invention is to provide a plasma melting furnace for waste treatment, as well as a system and a method for waste treatment using the same to minimize the harmful ingredients (e.g., dioxin, etc.) of an exhaust gas being discharged outside of the plasma melting furnace for waste treatment.

In addition, another aspect of the present invention is to provide a plasma melting furnace for waste treatment, as well as a system and a method for waste treatment using the same to sufficiently carry out thermal decomposition and melting of waste by increasing the path through which an exhaust gas flows in the plasma melting furnace for waste treatment.

Further, another aspect of the present invention is to provide a plasma melting furnace for waste treatment, as well as a system and a method for waste treatment using the same which can constantly maintain an internal temperature of the plasma melting furnace for waste treatment.

Further, another aspect of the present invention is to provide a plasma melting furnace for waste treatment, as well as a system and a method for waste treatment using the same which can maintain a high temperature of molten slag generated in the plasma melting furnace for waste treatment.

In one embodiment, provided is a plasma melting furnace for waste treatment by thermal decomposition and melting, including: a waste inlet formed on a first side wall of the plasma melting furnace to feed waste therein; an exhaust gas outlet which is formed on a second side wall facing the first side wall and located diagonally to a direction orthogonal to the first side wall on which the waste inlet is formed to discharge the exhaust gas generated in the plasma melting furnace; and a plasma torch which is mounted on a third side wall connecting the first side wall and the second side wall for heating the inside of the plasma melting furnace at a position nearer to the second side wall than the first side wall so as to inject a plasma into the exhaust gas before discharging the exhaust gas.

Herein, the exhaust gas outlet may be formed on the second side wall adjacent to a bottom section of the plasma melting furnace, and the plasma torch may be mounted on the third side wall on the bottom section side of a center portion of the third side wall so as to circulate the exhaust gas in an asymmetric circular shape in the plasma melting furnace by means of the plasma injected from the plasma torch.

In addition, the plasma torch may be mounted on the third side wall so as to inject the plasma obliquely toward the bottom section of the plasma melting furnace.

Further, a molten slag outlet for discharging molten slag may be formed on the third side wall under the plasma torch and near the bottom section so as to maintain a molten state of the molten slag by the plasma injected from the plasma torch.

Further, a plurality of plasma torches may be mounted on the third side wall, and a plasma injected from any one of the plurality of plasma torches may be obliquely injected to a plasma injected from another plasma torch of the plurality of plasma torches, such that the plasmas injected from each of the two or more plasma torches of the plurality of plasma torches become more concentrated.

Furthermore, the plurality of plasma torches may include a first plasma torch configured to inject the plasma in a direction orthogonal to the third side wall, and a second plasma torch configured to obliquely inject the plasma toward the first side wall.

According to an embodiment, provided is a plasma melting system for waste treatment, including: the plasma melting furnace (supra) for waste treatment, wherein the exhaust gas discharged from the exhaust gas outlet of the plasma melting furnace is transferred to a gasification furnace which is connected with the plasma melting furnace.

Herein, the gasification furnace may be configured to control a temperature of the exhaust gas, and a gas composition by the feeding any one of steam, carbon, and air.

According to another embodiment, provided is a plasma melting method for waste treatment by thermal decomposition and melting, including: inputting waste into a plasma melting furnace through a waste inlet formed on a first side wall thereof; thermally decomposing and melting the waste in the plasma melting furnace; injecting plasma into an exhaust gas from a plasma torch mounted on a third side wall connecting the first side wall of the plasma melting furnace and a second side wall facing the first side wall to remove impurities contained in the exhaust gas; and discharging the exhaust gas from which impurities are removed through an exhaust gas outlet which is formed on the second side wall and located diagonally to a direction orthogonal to the first side wall on which the waste inlet is formed.

Herein, the plasma melting method for waste treatment may further include: circulating the exhaust gas in an asymmetric circular shape generated by the exhaust gas outlet formed on the second side wall on a side of a bottom section of the plasma melting furnace around a center portion of the second side wall and a plasma torch mounted on the third side wall near the bottom section of the plasma melting furnace so as to obliquely inject the plasma toward the bottom section thereof.

According to the present invention, it is possible to minimize the harmful ingredients (e.g., dioxin, etc.) of an exhaust gas discharged outside of the plasma melting furnace for waste treatment and to sufficiently carry out thermal decomposition and melting of waste by increasing a path through which the exhaust gas flows in the plasma melting furnace for waste treatment.

Further, according to the present invention, it is also possible to constantly maintain the internal temperature of the plasma melting furnace for waste treatment, and maintain a high temperature of molten slag generated in the plasma melting furnace for waste treatment.

Therefore, according to the present invention, waste can be stably processed in the plasma melting furnace for waste treatment.

### BRIEF DESCRIPTION OF THE DRAWINGS

The above and other embodiments, features and other advantages of the present invention will be more clearly understood from the following detailed description taken in conjunction with the accompanying drawings, in which:

FIG. 1 is a schematic perspective view of a plasma melting furnace for waste treatment according to one embodiment of the present invention;

FIG. 2 is a cross-sectional view of the plasma melting furnace for waste treatment according to one embodiment of the present invention as seen from above; and

FIG. 3 is a cross-sectional view of the plasma melting furnace for waste treatment according to one embodiment of the present invention as seen from a side direction;

FIG. 4 is a schematic view of a plasma melting system for waste treatment according to one embodiment of the present invention; and

FIG. 5 is a flow chart of a plasma melting method for waste treatment according to one embodiment of the present invention.

### DETAILED DESCRIPTION

Hereinafter, exemplary embodiments of the present invention will be described with reference to the accompanying drawings. Therefore, embodiments and drawings described herein are simply exemplary and not exhaustive, and it will be understood that various modifications and equivalents may be made.

First, a plasma melting furnace including a plasma torch for heating the inside of the furnace to thermally decompose and melt waste will be described.

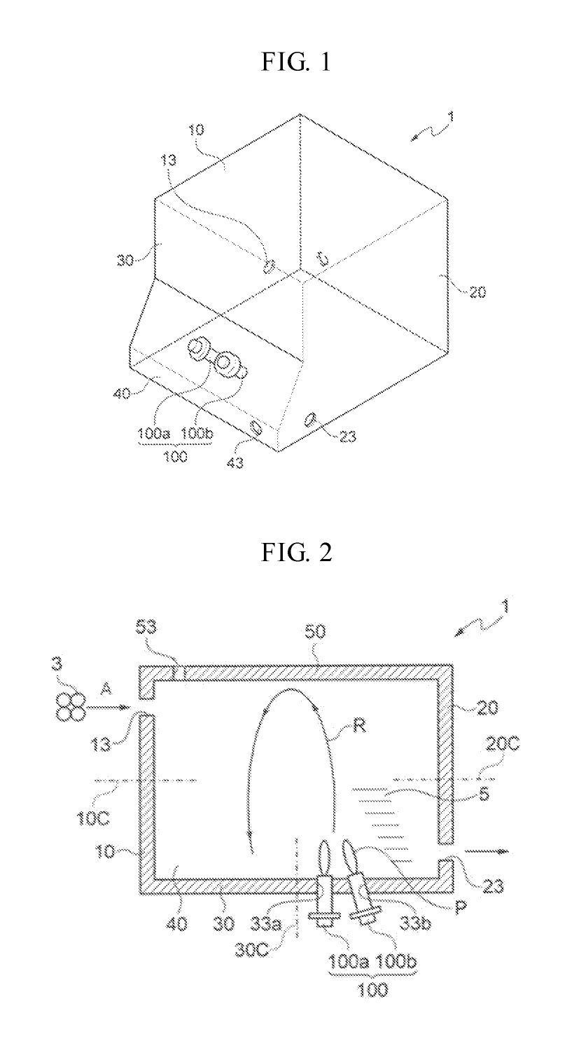

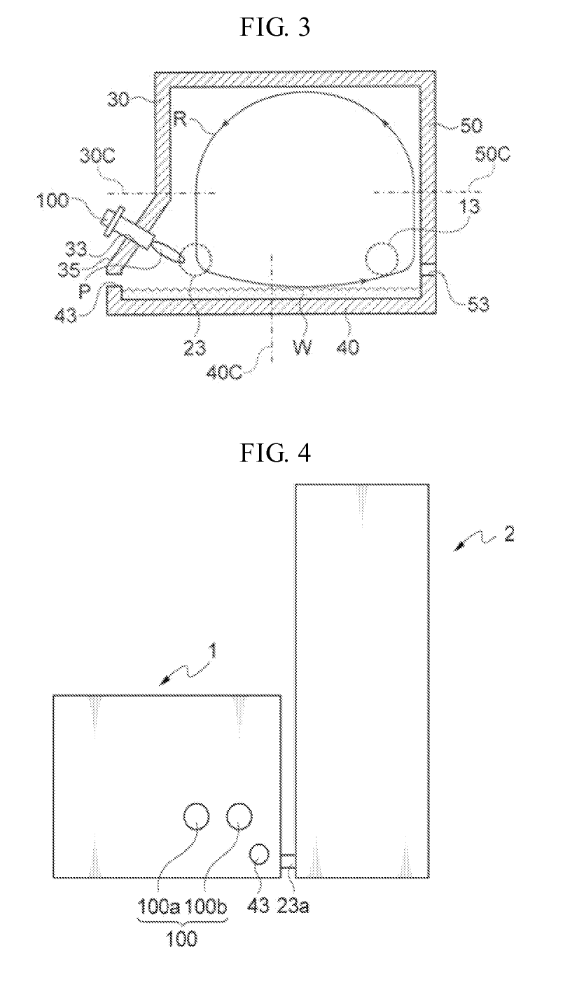

FIGS. 1 to 3 are views of the plasma melting furnace according to at least one embodiment of the present invention. In particular, FIG. 1 is a schematic perspective view of a plasma melting furnace for waste treatment according to one embodiment of the present invention, FIG. 2 is a cross-sectional view of the plasma melting furnace for waste treatment according to one embodiment of the present invention as seen from above, and FIG. 3 is a cross-sectional view of the plasma melting furnace for waste treatment according to one embodiment of the present invention as seen from a side direction.

As illustrated in FIGS. 1 to 3, the plasma melting furnace for waste treatment according to one embodiment of the present invention includes a waste inlet 13 formed on a first side wall 10 of a plasma melting furnace 1 to feed waste 3 therein. The waste 3 is transferred near to the waste inlet 13 from a waste conveying device (not illustrated) which is connected to the waste inlet 13, and then fed into the plasma melting furnace 1 through the waste inlet 13 in the direction of arrow A. For instance, the waste conveying device transfers waste that is passed through a waste crusher and then collected in a hopper or the like to the waste inlet 13.

Herein, as illustrated in FIG. 2, the waste inlet 13 is formed on the first side wall 10 of the plasma melting furnace 1 by being positioned toward one side from the center thereof. Specifically, in FIG. 2, the waste inlet 13 is formed on an upper side of the plasma melting furnace 1, that is, on an opposite side of a third side wall 30 based on a centerline 10C of the first side wall 10.

Meanwhile, waste 3 fed into the plasma melting furnace 1 is subjected to thermal decomposition and melting processes. Specifically, the waste 3 is thermally decomposed and becomes molten under a high temperature atmosphere. The high temperature atmosphere in the plasma melting furnace 1 is formed by preheated air injected through a preheated air inlet 53 which is formed on a side wall 50 facing the third side wall 30 adjacent to a bottom section 40 side based on a centerline 50C of the side wall 50, and a hot plasma injected from plasma torches 100 which are mounted on the third side wall 30. During the thermal decomposition and melting processes, an exhaust gas 5 and slag, which is ungasified-unreacted material, are formed inside the plasma melting furnace 1.

Herein, as illustrated in FIG. 2, the exhaust gas 5 is discharged outside of the plasma melting furnace 1 through an exhaust gas outlet 23 which is formed on a second side wall 20 facing the first side wall 10. In addition, as illustrated in FIG. 3, the molten slag (W) is discharged outside of the plasma melting furnace 1 through a molten slag outlet 43 which is formed on the third side wall 30, while staying on the bottom section 40. In this regard, the molten slag outlet 43 may be formed under the plasma torch 100, that is, on the bottom section 40 side.

As illustrated in FIG. 2, the exhaust gas outlet 23 is formed on the second side wall 20 of the plasma melting furnace 1 by being positioned toward one side from a center portion of the second side wall 20 of the plasma melting furnace 1. Specifically, in FIG. 2, the exhaust gas outlet 23 is formed on a lower side of the plasma melting furnace 1, that is, toward the third side wall 30 side based on a centerline 20C of the second side wall 20. Therefore, the waste inlet 13 and the exhaust gas outlet 23 are located diagonally with respect to each other in the plasma melting furnace 1. In particular, as illustrated in FIG. 2, the waste inlet 13 is located on the upper side of the centerline 10C of the first side wall 10 and the exhaust gas outlet 23 is located on the lower side of the centerline 20C of the second side wall 20, thereby the exhaust gas outlet 23 is located diagonally to a direction orthogonal to the first side wall 10 on which the waste inlet 13 is formed. In other words, the exhaust gas outlet 23 is located in a diagonal direction oblique to the direction orthogonal to the first side wall 10 as seen from the waste inlet 13. Such a position of the exhaust gas outlet 23 to the waste inlet 13 can be described as the waste inlet 13 is located diagonally to a direction orthogonal to the second side wall 20 of the exhaust gas outlet 23.

As described above, since the waste inlet 13 and the exhaust gas outlet 23 are located diagonally with respect to each other, a path through which the waste 3, fed from the waste inlet 13 into the inside of the plasma melting furnace 1, flows becomes long. Therefore, it is possible to have enough time to thermally decompose and melt the waste 3 fed into the plasma melting furnace 1. In addition to this, since the waste inlet 13 and the exhaust gas outlet 23 can be maximally spaced apart, effects due to the lowering of the temperature of the exhaust gas, which may be generated by waste ingredients that have not been thermally decomposed or become molten by insufficient heating, and thus affect the exhaust gas discharged through the exhaust gas outlet 23, can be minimized.

The plasma torch 100 has the function of heating the inside of the plasma melting furnace 1 to maintain the same at a high temperature atmosphere and ensures the molten slag stays in a uniformly molten state. The plasma torch 100 is provided on the third side wall 30 connecting the first side wall 10 on which the waste inlet 13 is formed and the second side wall 20 on which the exhaust gas outlet 23 is formed. Specifically, the plasma torch 100 is mounted on the third side wall 30 in such a way that two plasma torches 100 are inserted in a plasma torch insert hole 33a and 33b formed on the third side wall 30. Herein, the plasma torch 100 may be a torch that generates heated plasma by arc discharge.

Herein, the plasma torch 100 may be mounted on the third side wall 30 at a position nearer to the second side wall 20 than the first side wall 10. In other words, in FIG. 2, the plasma torch 100 may be mounted on a right side based on the centerline 30C of the third side wall 30, that is on the second side wall 20 side. Therefore, the plasma torch 100 can inject a hot-temperature plasma P to the exhaust gas 5 formed in the plasma melting furnace 1 before the exhaust gas 5 is discharged through the exhaust gas outlet 23 formed on the second side wall 20. As described above, when the exhaust gas 5 is exposed to the plasma before discharging, harmful gas ingredients such as dioxin, etc., which may remain in the exhaust gas 5 are eliminated, and thereby the danger wherein harmful gas is leaked from the plasma melting furnace 1 can be minimized.

Meanwhile, the plasma torch 100 may be mounted on the third side wall 30 of the plasma melting furnace 1 adjacent to the bottom section 40 side of the plasma melting furnace 1 based on the center portion of the third side wall 30, specifically in FIG. 3, on the lower side of the centerline 30C of the third side wall 30, that is, on the bottom section 40 side. Therefore, the exhaust gas 5 is subjected to a rotational force generated by the plasma (P) injected from the plasma torch 100, such that the exhaust gas 5 circulates (i.e., along an arrow (R) in FIG. 3) in the plasma melting furnace 1.

Accordingly, when the exhaust gas 5 circulates along the arrow (R) in the plasma melting furnace 1, it is possible to prevent or minimize fly ash which may be contained in the exhaust gas 5 from being discharged from the plasma melting furnace 1.

That is, when the exhaust gas 5 is circulated along the arrow (R) in the plasma melting furnace 1, the fly ash contained in the exhaust gas 5 is subjected to a centrifugal force in a radial direction, such that the fly ash is moved to be adjacent to an inner wall of the plasma melting furnace 1. Therefore, the fly ash continues to move inside of the plasma melting furnace 1 or is adhered to the inner wall of the plasma melting furnace 1. As a result, the fly ash may stay in the plasma melting furnace 1, and the fly ash is prevented or minimized from being discharged outside of the plasma melting furnace 1. According to one embodiment of the present invention, since the exhaust gas 5 comes into contact with the plasma injected from plasma torches 100 before being discharged outside via exhaust gas outlet 23, even if the fly ash directed to near the inside of the plasma melting furnace 1 flows around the exhaust gas outlet 23, discharge of the fly ash is prevented or minimized whereby the fly ash is re-calculated Therefore, this embodiment of the present invention needs no additional structure, such as a partition installed near the exhaust gas outlet 23, for preventing the fly ash from discharging through the exhaust gas outlet 23. Thus, it is possible to reduce the costs for installing a partition or maintaining the partition that must endure the high temperature atmosphere.

Further, in accordance with the plasma melting furnace for waste treatment according to one embodiment of the present invention, the plasma torch 100 is mounted on the third side wall 30 at a position nearer to the second side wall 20 than the first side wall 10 to be spaced apart from the center of the third side wall 30. Therefore, the exhaust gas 5 to which a rotational force is applied by contact with the plasma (P) injected from the plasma torch 100 is directed to an asymmetric space which is asymmetric to a direction orthogonal to a moving direction thereof. Further, since both spaces, that is, a space in the direction of the first side wall 10 and a space in the direction of the second side wall 20 are not symmetric with respect to each other in the direction orthogonal to the moving direction of the exhaust gas 5, the exhaust gas 5 is circulated in an asymmetric circular shape, and thereby a non-laminar flow is formed between the space of the first side wall 10 side and the space of the second side wall 20 side. Therefore, the exhaust gas 5 circulated along the arrow (R) of FIG. 3 flows with a cross section of the asymmetric circular shape in the plasma melting furnace 1, as well as the length of the path being increased through which the exhaust gas 5 flows in the plasma melting furnace for waste treatment. Further, a mixing of gases in the plasma melting furnace 1 is improved due to the turbulence flow of the exhaust gas 5 formed therein, such that the internal temperature of the plasma melting furnace 1 can be uniformly maintained.

In addition, in accordance with the plasma melting furnace for waste treatment according to one embodiment of the present invention, since the plasma torch 100 is provided so as to obliquely inject the plasma (P) toward the bottom section 40 of the plasma melting furnace 1, the rotational force applied to the exhaust gas 5 can be enhanced, and thereby the exhaust gas 5 is further circulated in the plasma melting furnace 1.

Herein, as illustrated in FIG. 3, in order to obliquely inject the plasma (P) from the plasma torch 100 toward the bottom section 40 of the plasma melting furnace 1, an inclined portion 35 is formed at the third side wall 30 of the plasma melting furnace 1 so as to be inclined toward the bottom section 40, and the plasma torch 100 is installed in a plasma torch insert hole 33 which is formed orthogonally to the inclined direction of the inclined surface 35. However, the present invention is not limited thereto. For example, it is possible that the plasma torch insert hole 33 is obliquely formed in the third side wall 30 toward the bottom section 40 of the plasma melting furnace 1 without forming the inclined surface 35, and the plasma torch 100 is inserted in the plasma torch insert hole 33 in a longitudinal direction so as to obliquely inject the plasma (P) toward the bottom section 40.

Further, as illustrated in FIG. 2, the plasma melting furnace 1 according to one embodiment of the present invention may include a plurality of plasma torches 100. For example, when the plasma melting furnace 1 includes two plasma torches 100, a second plasma torch 100b is mounted at a different angle with respect to a first plasma torch 100a, whereby the plasma (P) from the second plasma torch 100b is injected obliquely with respect to the plasma (P) from the first plasma torch 100a, such that the plasma (P) injected from the first plasma torch 100a and the plasma (P) injected from the second plasma torch 100b can be concentrated at a point in a direction orthogonal to the third side wall 30. Therefore, plasma effects achieved from the plasma melting furnace 1 according to one embodiment of the present invention can be maximized. For example, it is possible to uniformly maintain a melting condition of the molten slag and maximally remove impurities contained in the exhaust gas 5.

Further, the plasma melting furnace 1 may include a plurality of plasma torches 100 in such a way that an injection direction of the plasma (P) from the plasma torch 100 can be controlled. In this case, the length of the path through which the exhaust gas 5 flows in the plasma melting furnace 1 is increased, and thereby impurities contained in the exhaust gas 5 can be maximally removed and the internal temperature of the plasma melting furnace 1 can be uniformly maintained. Herein, the plurality of plasma torches 100 may include the first plasma torch 100a for injecting the plasma (P) in the direction orthogonal to the third side wall 30, and the second plasma torch 100b for injecting the plasma (P) at an angle with respect to the plasma (P)injected from the first plasma torch 100a so as to be concentrated at a point in a direction orthogonal to the third side wall 30.

For this, an example wherein the plasma melting furnace 1 includes two plasma torches 100 is specifically described. As illustrated in FIG. 2, the first plasma torch 100a injects the plasma (P) in the direction substantially orthogonal to the third side wall 30, while the second plasma torch 100b obliquely injects the plasma (P) toward the first side wall 10 in the direction substantially orthogonal to the third side wall 30.

In this way, if the second plasma torch 100b injects the plasma (P) at an angle toward the first side wall 10, the exhaust gas 5 facing the plasma (P) is subjected to a force not only in the direction orthogonal to the third side wall 30, but also to the first side wall 10 side, and thereby the exhaust gas 5 is rotated and flowed to the first side wall 10 side (i.e., along the arrow (R) in FIG. 2). Accordingly, as the exhaust gas 5 moves further away from the exhaust gas outlet 23 formed on the second side wall 20, and the length of the flow path of the exhaust gas 5 in the plasma melting furnace 1, before discharging, is increased. Therefore, it is possible to sufficiently remove the impurities contained in the exhaust gas 5 and efficiently and uniformly maintain the internal temperature of the plasma melting furnace 1.

In addition, the plasma melting furnace 1 according to one embodiment of the present invention may further include the molten slag outlet 43 for discharging the molten slag (W) generated in the plasma melting furnace 1. Slag, such as inorganic substances that are not gasified in the plasma melting furnace 1, forms the molten slag (W) due to the high temperatures of the plasma melting furnace 1. As illustrated in FIG. 3, the molten slag outlet 43 may be formed on the third side wall 30 under the plasma torch 100 so as to be located near to the plasma torch 100. Therefore, the molten slag (W) is properly maintained in a molten state at least around the molten slag outlet 43 due to the plasma (P) injected from the plasma torch 100. Since the molten slag (W) properly maintained in a molten state can be easily discharged through the molten slag outlet 43, clogging of the molten slag outlet 43, by issues such as solidification of the molten slag (W), can be prevented. Of course, as a result, it is possible to reduce the costs for maintenance and repair of the plasma melting furnace 1 caused by issues such as clogging of the molten slag outlet 43.

Further, in the plasma melting furnace 1 according to one embodiment of the present invention, since the molten slag outlet 43 is located near the plasma torch 100, the molten slag outlet 43 is located as far away from the waste inlet 13 formed on the first side wall 10 as possible. By this arrangement, molten slag (W) disposed around the molten slag outlet 43 may be sufficiently separated from the waste 3 newly input from the waste inlet 13, thereby problems with flow of the molten slag (W), caused by cooling or solidification thereof, can be removed.

A plasma melting system for waste treatment according to one embodiment of the present invention will be described with reference to FIG. 4. The plasma melting system for waste treatment according to one embodiment of the present invention includes the specifically mentioned above plasma melting furnace 1, and the exhaust gas discharged from the exhaust gas outlet 23 which is formed in the plasma melting furnace 1 is transferred to a gasification furnace 2 which is connected with the plasma melting furnace 1 through a connecting pipe 23a. The gasification furnace 2 can be used to control the temperature of the exhaust gas and a gas composition by the feeding of steam, carbon, air, or the like. In this way, the plasma melting furnace 1 and the gasification furnace 2 are separated from each other in the plasma melting system for waste treatment according to one embodiment of the present invention, thereby control of thermal decomposition and melting of the waste, and flow of exhaust gas can be independently carried out. Accordingly, overall control of the plasma melting system for waste treatment can be easily accomplished.

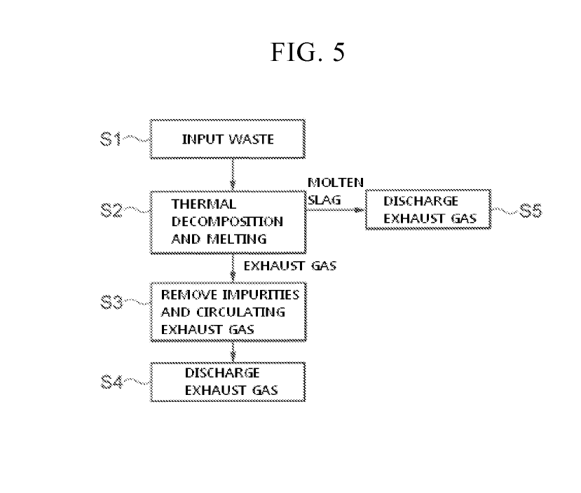

Further, a plasma melting method for waste treatment using the specifically mentioned plasma melting furnace 1, above, will be described with reference to FIG. 5. The plasma melting method for waste treatment according to one embodiment of the present invention includes inputting waste into the plasma melting furnace 1 through the waste inlet 13 which is formed on the first side wall 10 thereof (step S1), and thermally decomposing and melting the input waste in the plasma melting furnace 1 (step S2). In addition, the plasma melting method for waste treatment of the present invention includes injecting plasma (P) into the exhaust gas 5 from the plasma torch 100 mounted on the third side wall 30 connecting the first side wall 10 of the plasma melting furnace 1 and the second side wall 20 facing the first side wall 10 to remove impurities contained in the exhaust gas 5 (step S3). The plasma melting method for waste treatment of the present invention further includes discharging the exhaust gas 5 from which impurities are removed through the exhaust gas outlet 23 which is formed on the second side wall 20 and located diagonally to the direction orthogonal to the first side wall 10 on which the waste inlet 13 is formed (step S4). As mentioned above, since the exhaust gas 5 is exposed to the plasma (P) before discharging, impurities such as a harmful gas contained in the exhaust gas 5 are eliminated before discharge, and thereby impurities which may flow out from the plasma melting furnace 1 can be prevented or minimized.

The plasma melting method for waste treatment of the present invention may further include discharging the molten slag (W) on the bottom section 40 of the plasma melting furnace 1 through the molten slag outlet 43 which is formed on the third side wall 30 (step S5), after thermal decomposition and melting of the waste in step S2.

In addition, as an additional step which is carried out after step S3, or simultaneously with step S3, the plasma melting method for waste treatment of the present invention further includes a step of circulating the exhaust gas 5 along the arrow (R) in an asymmetric circular shape. The asymmetric circulating of the exhaust gas 5 generated by the exhaust gas outlet 23 formed on the second side wall 20 on a bottom section 40 side of the plasma melting furnace 1 of a center portion of the second side wall 20 and a plasma torch 100 mounted on the third side wall 30 near the bottom section 40 of the plasma melting furnace 1 so as to obliquely inject the plasma (P) toward the bottom section 40 of the plasma melting furnace 1. Therefore, it is possible to maximally remove impurities contained in the exhaust gas 5 and uniformly maintain the internal temperature of the plasma melting furnace 1.

While the invention was described in conjunction with exemplary embodiments, it will be understood that the present description is not intended to limit the invention to those exemplary embodiments. On the contrary, the invention is intended to encompass not only the exemplary embodiments, but also various alternatives, modifications, equivalents, and other embodiments thereof, which may be included within the spirit and scope of the invention as defined by the appended claims.

For example, in order to concentrate the plasma injected from a plasma torch, the plasma melting furnace includes a plurality of plasma torches so as to control the injection direction of the plasma to be concentrated at a point in the direction orthogonal to the third face, however, the position of the plasma torches is not limited to the configuration of the above mentioned embodiments of the present invention.

In addition, it should be understood that the terms “centerline” and “center portion” include not only a line orthogonal to any one side wall at a position of which is an exact center of the side wall and a portion thereof, but also a line orthogonal to any one side wall at a position which is near a center of the side wall and a portion thereof.

What is claimed is:

1. A plasma melting furnace for waste treatment by thermal decomposition and melting, the plasma melting furnace comprising:
a waste inlet formed on a first side wall of the plasma melting furnace to feed waste therein;
an exhaust gas outlet, which is formed on a second side wall facing the first side wall and located diagonally to an orthogonal direction of the waste inlet to the first side wall, formed to discharge the exhaust gas generated in the plasma melting furnace; and
a plasma torch, which is mounted on a third side wall connecting the first side wall and the second side wall for heating an inside of the plasma melting furnace, mounted at a position nearer to the second side wall than the first side wall so as to inject a plasma to the exhaust gas before the exhaust gas being discharged.

2. The plasma melting furnace for waste treatment according to claim 1, wherein the exhaust gas outlet is formed adjacent to a bottom section of the plasma melting furnace on the second side wall, and the plasma torch is mounted on a bottom section side of a center portion of the third side wall so as to circulate the exhaust gas in an asymmetric circular shape in the plasma melting furnace by means of the plasma injected from the plasma torch.

3. The plasma melting furnace for waste treatment according to claim 2, wherein the plasma torch is mounted on the third side wall so as to inject the plasma obliquely toward the bottom section of the plasma melting furnace.

4. The plasma melting furnace for waste treatment according to claim 2, wherein a molten slag outlet for discharging molten slag is formed on the third side wall under the plasma torch and adjacent to the bottom section so as to maintain a molten state of the molten slag by the plasma injected from the plasma torch.

5. The plasma melting furnace for waste treatment according to claim 1,
wherein a plurality of the plasma torches are mounted on the third side wall, and
a plasma injected from any one of the plurality of plasma torches is obliquely injected to a plasma injected from another plasma torch of the plurality of plasma torches, such that the plasmas injected from each of the two or more plasma torches of the plurality of plasma torches becomes concentrated.

6. The plasma melting furnace for waste treatment according to claim 5, wherein the plurality of plasma torches include a first plasma torch configured to inject the plasma in a direction orthogonal to the third side wall and a second plasma torch configured to inject the plasma obliquely to the injection direction of the first plasma torch toward the first side wall.

7. A plasma melting system for waste treatment, comprising:
the plasma melting furnace for waste treatment according to claim 1,
wherein the exhaust gas discharged from the exhaust gas outlet of the plasma melting furnace is transferred to a gasification furnace which is coupled with the plasma melting furnace.

8. The plasma melting system for waste treatment according to claim 7, wherein the gasification furnace is configured to control a temperature of the exhaust gas and a gas composition by feeding any one of steam, carbon, and air.

9. A plasma melting method for waste treatment, the method comprising:
feeding waste into a plasma melting furnace through a waste inlet formed on a first side wall thereof;
thermally decomposing and melting the waste in the plasma melting furnace;
injecting plasma to an exhaust gas from a plasma torch mounted on a third side wall connecting the first side wall of the plasma melting furnace and a second side wall facing the first side wall to remove impurities contained in the exhaust gas; and
discharging the exhaust gas from which impurities are removed through an exhaust gas outlet which is formed on the second side wall and located diagonally to an orthogonal direction of the waste inlet to the first side wall.

10. The plasma melting method for waste treatment according to claim 9, further comprising: circulating the exhaust gas in an asymmetric circular shape.
